(19) United States
(12) Patent Application Publication
(10) Pub. No.: US 2001/0056053 A1
(43) Pub. Date: Dec. 27, 2001

(54) Composition for application to vehicle surfaces to protect against and remove through dissolving upon washing insects and other dirt

(76) Inventor: J. Drew Harrison, Suwanee, GA (US)

Correspondence Address: Paul M. Denk, 763 South New Ballas Road, St. Louis, MO, 63141, US

(21) Appl. No.: 09/797,441

(22) Filed: Mar. 1, 2001

Related U.S. Application Data
(60) Provisional application No. 60/186,233, filed on Mar. 1, 2000.

(51) Int. Cl. C11D 1/00

(52) U.S. Cl. 510/180; 510/189; 510/473

(57) ABSTRACT

This invention is concerned with the application of a formulation that may be sprayed or applied to the surface of the vehicle, such as its grillwork, the bumper, to form a fine film, and against which and upon the surface thereof that insects impact, to facilitate their removal, once the driver has a reached a destination.

### CROSS-REFERENCE TO RELATED APPLICATIONS

This application is a non-provisional patent application based upon provisional patent application having Serial No. 60/186,233, filed on Mar. 1, 2000, which is owned by a common inventor.

### BACKGROUND OF THE INVENTION

There have been a variety of compositions and articles that can be applied to the vehicle, whether it be an automobile, truck, or the like, or even to the deck of a boat, to function as a means for diverting insects, other bugs, or dirt, from splashing against the front of the vehicle, or against the windshield, and splattering thereby decreasing the level of observing by the driver or other passenger. For example, there is a small plastic shield that has been applied upon the upper front surface of the hood of a vehicle, and tends to divert the insects or other debris that the vehicle is approaching, under high speed, upwardly into the air to obtain clearance above the hood, the windshield, and the top of the vehicle, to avoid the bugs from splattering against the windshield. In addition, there are various types of guards that can be applied to the front of the grillwork of a vehicle, particularly during highway travel, that can guard against the impacting of insects against its grillwork, or the radiator, and having, eventually, deleterious effects. These are known types of devices, as distinct from formulations, that have been available in the art, to minimize the effects of insects upon the surface of the vehicle, and its windshield.

### SUMMARY OF THE INVENTION

This invention is primarily concerned with the application of a formulation, of a chemical and liquid nature, that may be sprayed or applied to the surface of the vehicle, such as its paint, grillwork, bumper, headlights and license plate, to form a fine film, and against which and upon the surface thereof that the insect impacts, to facilitate removal, once the driver has a reached a destination, or the next service stop. For example, the chemical formulation is designed to dissolve, when exposed to water, whether it be from the application of a squeegee during washing, washing with a cloth, or simply spraying with a hose, such that the chemical formulation dissolves, and carries with it, upon removal, the residue of any insects that have been impacted against the vehicle, its grillwork, the hood and headlights.

The formulation of this invention is designed to achieve particular results, upon application. For example, initially, the formulation must form a thin film, such as a plastic-like film that dries and hardens upon application to the grillwork, or the windshield, and solidifies upon application, so as to form that film barrier against which the insect impacts, to prevent it from encountering directly the metallic surface of the grillwork, or the headlights, upon application. Secondly, the film must be sufficiently viscous, in its formulation, so as form, upon setting, a reasonable degree of thickness, so that the insect, upon impacting the vehicle, does not penetrate through the film, and encounter the metallic surface of the vehicle or its headlights Thirdly, the chemical formulation must be dissolvable, upon application of water, such that when water under pressure, as from a hose, or when applied by a squeegee, or when an application of a wet cloth to the surface of a vehicle is applied, the formulation immediately dissolves, and can be flushed away, carrying with it the residue of the insects that remain fter they have encountered the vehicle upon high speed highway travel.

It is, therefore, the principal object of this invention to provide a dissolvable screen that can be applied to select surfaces of the vehicle to shield against the impacting of insects, and perhaps even small debris such as sand and pebbles, from encountering directly the surface of the vehicle as during highway travel.

Another object of this invention is to provide a chemical formulation which forms a film upon the surface of a vehicle, and which is dissolvable when subjected to treatment by water, so as to flush away the film, and any residue of insects that remain after their impacting upon the surface of the parts of the automobile or truck.

Another object of this invention is to provide a film that may add to the protectiveness of the surface of the vehicle, particularly during extended highway or other high speed travel.

Still another object of this invention is to provide a chemical formulation that not only protects the surface of the vehicle, but can be easily flushed away, upon the application of water, to function as a protectant against the vehicle surfaces, during usage.

These and other objects may become more apparent to those skilled in the art upon reviewing the subject matter of this invention, and upon undertaking a study of the description of its preferred embodiment.

### DESCRIPTION OF THE PREFERRED EMBODIMENT

This invention contemplates the formation of a chemical formulation which when mixed together, and when applied into a container for spraying, or when applied under pressure in an aerosol container, or liquid spray bottle, can be sprayed onto the surfaces of a vehicle, boat, or other means of travel, and function as a protectorant for particularly those surfaces that encounter the impact of insects, or other debris, as during travel. In addition, the formulation of this invention may be applied by other means, such as by a brush, or by application through the use of a cloth, in order to form a film-like surface upon those areas of the vehicle that are impacted by debris, as during travel.

Once the formulation is applied to the vehicle, as upon its grillwork, the head lights, the front surfaces of the vehicle that encounter air pressure during high speed travel, and which have a forward exposure, and against which insects will impact during travel, whether it be of an automobile, truck, van, motorcycle, bus or boat, and which adds protection to these surfaces, and preserve them for a longer life, during extended usage. The formulation essentially includes means that affords its dissolving, or breakdown, when encountering water, so that when the film has been applied, and the vehicle has been used for extended travel, water may be applied by a variety of means, whether it be from spraying with a hose, a squeegee, brush, or washing with a wet rag, to provide for immediate dissolving of the previously applied film, and upon flushing, carry away both the residue film, and any remaining insects or parts thereof, that need to be removed from the surface of the vehicle, in order to sustain its natural luster

The formulation of this invention includes water, alcohol, cellulose, and wetting agent.

A more specific formulation for this invention may include the various ingredients, in their following percentages, by volume. Water may be included in a range of 2% to 50%, the alcohol may be added in the amount of 50% to 98%, the wetting agent may be included in an amount of 0.5% to 2%, and the cellulose may be included in the composition of the formulation in an amount of 2% to 4%, by volume. A preservative may be included in the amount of 0.001%.

Typical examples of wetting agents, in the category of surfactants, that can be used, by way of example, as a wetting agent in the formulation for the composition of this invention, includes polyoxyethylene non-ionics, glycerol monostearate, polypropylene glycol monolaurate, polyoxyethylene(4), (2), (20) or (40) sorbitan monostearate, and related polyoxyethylene surfactants, and sodium laurel sulfate, as an example of typical wetting agents that may be used within this composition.

Examples of the type of cellulose that may be applied include starches, crystalline celluloses, microcrystalline celluloses, or cellulose acetate phthalate, and equivalent type of cellulosic compositions, that may add to the wetting and dissolving of the composition, when it is desired to dissolve it, and the entrained debris, bugs, and other deleterious dirt, that has accumulated upon the surface of the vehicle.

The application of the above formulation, particularly when applied with a sprayer container, or when discharged from an aerosol vessel, may be immediately and directly applied to the frontal surfaces of the vehicle, and upon application thereto, immediately cures to provide and furnish a formed film that can function as a barrier, against which insects or other debris may encounter, when the vehicle is utilized for high speed travel, as over the highway, and during extended usage. Hence, the usage of this formulation for the identified purpose not only facilitates for the owner the task of cleaning his/her vehicle, after extended usage, but in addition, once the cleaning has been fulfilled, the natural luster and surface of the vehicle should be preserved, therefore enhancing at least the cosmetic appearances of the vehicle for extended usage, for further extending the life of the vehicle itself.

Variations or modifications to the subject matter of this invention may occur to those skilled in the art upon reviewing the summary as provided herein. Such variations or modifications, if within the subject matter of this development, are intended to be encompassed within the scope of the invention as described herein. The description of the preferred embodiment as set forth herein is done so for illustrative purposes only.

I claim:

1. A composition for application to vehicle surfaces to protect against and remove through dissolving any insects or other dirt that accumulates on the vehicle surface after the composition has been added, the formulation for the composition including water, alcohol, and cellulose, such that when the formulation is applied to the surface of the vehicle, and dirt accumulates thereon, a spraying or wetting of the surface with water dissolves the composition and facilely removes the accumulated dirt.

2. The invention of claim 1 wherein the said ingredients are included in the composition in the following percentages by volume:

| | |
|---|---|
| Water: | 2% to 50% |
| Alcohol: | 50% to 98% |
| Wetting Agent: | .5% to 2% |
| Cellulose: | 2% to 4% |

3. The invention of claim 2 wherein the wetting agent comprising a surfactant selected from the group consisting of polyoxyethylene non-ionics, glycerol monostearate, propylene glycol monolaurate, polyoxyethylene(2), (4), (20) or (40) sorbitan monostearate, and sodium laurel sulfate.

4. The invention of claim 2 wherein the cellulose may be selected from the group consisting of starch, crystalline cellulose, monocrystalline cellulose, cellulose acetate phthalate, and equivalent surfactants.

5. The invention of claim 1 and including a wetting agent in the composition.
